(19) United States
(12) Patent Application Publication
(10) Pub. No.: US 2025/0258473 A1
(43) Pub. Date: Aug. 14, 2025

(54) CONTROL SYSTEM WITH TRIPLE MODULAR REDUNDANCY USING SEPARATE CONTROLLERS

(71) Applicant: ROCKWELL AUTOMATION TECHNOLOGIES, INC., MAYFIELD HEIGHTS, OH (US)

(72) Inventors: Gary Dan Dotson, Muskego, WI (US); Eric M. Jonardi, Greendale, WI (US); David S. Wehrle, Chesterland, OH (US)

(21) Appl. No.: 18/441,859

(22) Filed: Feb. 14, 2024

(51) Int. Cl. G05B 19/05

(52) U.S. Cl. CPC G05B 19/054; G05B 19/058; G05B 2219/14016

(57) ABSTRACT

A control system with triple modular redundancy (TMR) using separate controllers includes a first controller device, a second controller device, a third controller device, and an input/output (I/O system). The I/O system receives redundant output data packets from the first controller device, the second controller device, and the third controller device. The I/O system further evaluates the redundant data packets based on a voting process, generates a control input responsive to evaluating the redundant data packets based on the voting process, and provides the control input to the first controller device, the second controller device, and the third controller device.

### BACKGROUND INFORMATION

The subject matter disclosed herein relates generally to industrial control systems, and more particularly to systems, methods, media, and devices that can be used to provide improved reliability in industrial control systems.

### BRIEF DESCRIPTION

One aspect of the present disclosure is a control system. The control system includes a first controller device including circuitry configured to generate and transmit a first redundant output data packet associated with the control system; a second controller device including circuitry configured to generate and transmit a second redundant output data packet associated with the control system; and a third controller device including circuitry configured to generate and transmit a third redundant output data packet associated with the control system. The control system further includes an input/output (I/O) system including circuitry configured to receive the first redundant output data packet, the second redundant output data packet, and the third redundant output data packet from the first controller device, the second controller device, and the third controller device; evaluate the first redundant output data packet, the second redundant output data packet, and the third redundant output data packet based on a voting process; generate a control input responsive to evaluating the first redundant output data packet, the second redundant output data packet, and the third redundant output data packet based on the voting process; and provide the control input to the first controller device, the second controller device, and the third controller device such that the first controller device, the second controller device, and the third controller device use the control input to affect operation of equipment in the control system.

Another aspect of the present disclosure is a method for use in a control system. The method includes receiving, from a first controller device, a first redundant output data packet associated with the control system; receiving, from a second controller device, a second redundant output data packet associated with the control system; receiving, from a third controller device, a third redundant output data packet associated with the control system; evaluating the first redundant output data packet, the second redundant output data packet, and the third redundant output data packet based on a voting process; generating a control input responsive to evaluating the first redundant output data packet, the second redundant output data packet, and the third redundant output data packet based on the voting process; and providing the control input to the first controller device, the second controller device, and the third controller device such that the first controller device, the second controller device, and the third controller device use the control input to affect operation of equipment in the control system.

Yet another aspect of the present disclosure is one or more non-transitory computer-readable storage media having instructions stored thereon that, when executed by processing circuitry, cause the processing circuitry to receive, from a first controller device, a first redundant output data packet associated with a control system; receive, from a second controller device, a second redundant output data packet associated with the control system; receive, from a third controller device, a third redundant output data packet associated with the control system; evaluate the first redundant output data packet, the second redundant output data packet, and the third redundant output data packet based on a voting process; generate a control input responsive to evaluating the first redundant output data packet, the second redundant output data packet, and the third redundant output data packet based on the voting process; and provide the control input to the first controller device, the second controller device, and the third controller device such that the first controller device, the second controller device, and the third controller device use the control input to affect operation of equipment in the control system.

### BRIEF DESCRIPTION OF THE DRAWINGS

FIG. 1 is a block diagram illustrating example components of an example control system, in accordance with some aspects of the disclosure.

FIG. 2 is a block diagram illustrating example components of another example control system, in accordance with some aspects of the disclosure.

FIG. 3 is a flowchart illustrating steps of an example process for providing triple modular redundancy using separate controllers that can be implemented in the control system of FIG. 1 or in the control system of FIG. 2, in accordance with some aspects of the disclosure.

### DETAILED DESCRIPTION

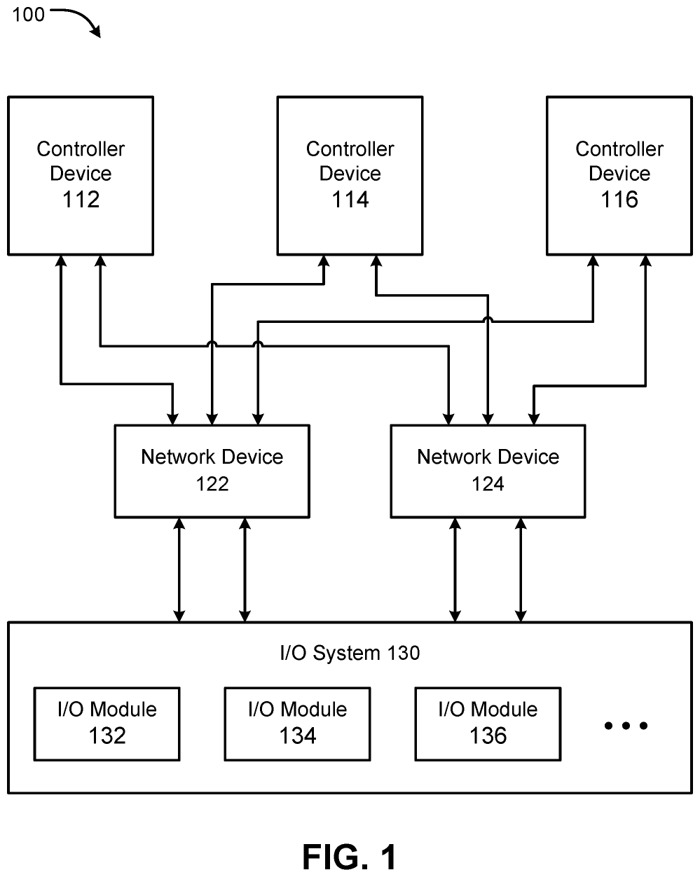

Referring to FIG. 1, a block diagram illustrating example components of an example control system 100 is shown, in accordance with some aspects of the disclosure. As shown, the control system 100 includes a controller device 112, a controller device 114, and a controller device 116 as well as a network device 122 and a network device 124. Further, the control system 100 is shown to include an input/output (I/O) system 130 that includes an I/O module 132, an I/O module 134, and an I/O module 136. The control system 100 can generally be used to control the operation of various types of equipment in various types of industrial facilities. For example, the control system 100 can be implemented in manufacturing facilities in industries such as aerospace, automotive, cement, chemical processing, food and beverage, household and personal care, life sciences, marine operations, metals processing, mining operations, oil and gas, power generation, print and publishing, pulp and paper, semiconductors, warehouse and fulfillment, and wastewater treatment, among others. In some implementations, the improved reliability that can be provided by the control system 100 can be particularly advantageous in industries such as oil and gas, chemical processing, and other safety critical automation environments.

The example components of the control system 100 including the controller device 112, the controller device 114, the controller device 116, the network device 122, the network device 124, and the I/O system 130 including the I/O module 132, the I/O module 134, and the I/O module 136 can be in electrical communication with each other either directly or indirectly using various types and combinations of communications networks, protocols, and networking equipment. For example, the components of the control system 100 can communicate with each other using various types of wired and/or wireless communications including Ethernet Industrial Protocol (Ethernet/IP) communications, serial communications, Common Industrial Protocol (CIP) safety communications, and other suitable communications protocols. For example, the components of the control system 100 can communicate with each other via one or more local area networks (LAN) in a manufacturing facility.

The controller device 112 can be implemented as a programmable logic controller (PLC) device, among other possible types of controller devices that can be used in an industrial control system. The controller device 112 can include any suitable hardware, software, firmware, and communications interfaces (e.g., Ethernet communications port(s), serial communications port(s), power interface(s), etc.) for performing control functions within the control system 100. The controller device 112 can execute one or more control loops to process inputs and outputs and send control signals to affect operation of equipment in the control system 100. The controller device 112 can include various suitable configurations of hardware processing circuitry and memory. For example, the controller device 112 can include one or more central processing units (CPUs) and/or other types of hardware processing circuitry. The processing circuitry can be implemented using any number of processing cores, including single core processors, dual core processors, and other processor core configurations. The memory can include any suitable types of memory including different types of volatile memory, non-volatile memory, random-access memory (RAM), read-only memory (ROM), electrically erasable programmable read-only memory (EEPROM), and/or other types of memory. The memory of the controller device 112 can include non-transitory computer readable storage media having instructions stored thereon for execution by the processing circuitry of the controller device 112 to cause the controller device 112 to perform various operations. For example, the instructions can cause the controller device 112 to implement the functionality pertaining to triple modular redundancy as described herein.

The controller device 114 and the controller device 116 can likewise be implemented in various ways, and can each include the same or similar components as discussed above with respect to the controller device 112. In some implementations, advantages can be provided when the controller device 112, the controller device 114, and the controller device 116 each have only a single core CPU to perform processing functionality. In such an implementation, the controller device 112, the controller device 114, and the controller device 116 can be provided at a lower cost relative to comparable devices that include multiple processors and/or multiple processor cores. Further, the controller device 112, the controller device 114, and the controller device 116 can be networked together to provide triple modular redundancy using separate controllers. Since multiple separate devices are used in such an implementation, improvements in terms of reliability can be provided relative to alternative implementations that use a single controller device with multiple processors and/or processor cores that provide triple modular redundancy via that single device. The circuitry of the controller device 112, the controller device 114, and the controller device 116 can be configured to generate and transmit various types of redundant output data packets (e.g., indicative of measured process variables, states, etc.) to the I/O system 130. The circuitry of the controller device 112, the controller device 114, and the controller device 116 can also be configured to receive control inputs (e.g., input data packets) from the I/O system 130 and use the control inputs to affect operation of equipment in the control system 130.

The network device 122 can be implemented in a variety of ways, such as using various types of network switch devices and other suitable types of networking devices. The network device 122 can generally provide a communications interface between the controller device 112, the controller device 114, the controller device 116 and the I/O system 130. For example, the network device 122 can receive output data packets from the controller device 112, the controller device 114, and the controller device 116 and appropriately route the output data packets to the I/O system 130. The network device 122 can also receive control inputs from the I/O system 130 and appropriately route the control inputs to the controller device 112, the controller device 114, and the controller device 116.

The network device 122 can also include various suitable configurations of hardware processing circuitry and memory. For example, the network device 122 can include one or more CPUs and/or other types of hardware processing circuitry. The processing circuitry can be implemented using any number of processing cores, including single core processors, dual core processors, and other processor core configurations. The memory can include any suitable types of memory including different types of volatile memory, non-volatile memory, RAM, ROM, EEPROM, and/or other types of memory. The memory of the network device 122 can include non-transitory computer readable storage media having instructions stored thereon for execution by the processing circuitry of the network device 122 to cause the network device 122 to perform various operations. For example, the instructions can cause the network device 122 to implement the functionality pertaining to routing communications related to triple modular redundancy as described herein. The network device 124 can likewise be implemented in various ways, and can include the same or similar components as discussed above with respect to the network device 122. The network device 122 and the network device 124 can, in some examples, facilitate black channel communication between the controller device 112, the controller device 114, and the controller device 116 and the I/O system 130 based on parallel redundancy protocol (PRP).

The I/O system 130 can also be implemented in a variety of ways using different types of components and configurations. For example, the I/O system 130 can be implemented as a FLEXHA 5000 I/O System as provided by Rockwell Automation, Inc., among other similar types of I/O systems. The I/O system 130 can include, for example, one or more backplanes such as redundant backplanes that provide communications between different components of the I/O system 130. The I/O system 130 can generally be a “high availability” (HA) system that can provide above a threshold level of uptime (e.g., a threshold uptime percentage, etc.). The I/O system 130 can include various mechanical and electromechanical components such as mounting plates, terminal blocks, power conditioners, network adapters, landing cards, interface modules, adapter bases, ground lugs, expansion bases, shielding components, cables and other wiring, power supply modules, and/or other suitable components. The I/O system 130 can be installed in various locations in a given facility such as within a given electrical cabinet or distributed across multiple electrical cabinets.

While the I/O system 130 is shown to include three I/O modules including the I/O module 132, the I/O module 134, and the I/O module 136, the I/O system 130 can be implemented using a variety of I/O module configurations. For example, the I/O module 132, the I/O module 134, and the I/O module 136 can provide a triple simplex I/O configuration, where each of the I/O module 132, the I/O module 134, and the I/O module 136 communicate with a respective one of the controller device 112, the controller device 114, and the controller device 116 to provide triple modular redundancy. As another example, the I/O system 130 could be implemented using just the I/O module 132 and the I/O module 134, where each of the I/O module 132 and the I/O module 134 are duplex (redundant) modules. The I/O module 132, the I/O module 134, and the I/O module 136 can each be rated for Safety Integrity Level (SIL) 2. The controller device 112, the controller device 114, and the controller device 116 can likewise each be rated for SIL2. However, by networking these components together and implementing the functionality described herein, a higher rating of SIL3 can be provided for the control system 100 more broadly. The processing steps described herein as being performed by circuitry of the I/O system 130 can be performed by different components and/or combinations of components of the I/O system 130 depending on the application.

As suggested by the block diagram shown in FIG. 1, the controller device 112, the controller device 114, and the controller device 116 can each send redundant copies of the same output data packet to both the network device 122 and the network device 124. Then, the network device 122 and the network device 124 can each send redundant packets containing the output data from the controller device 112, the controller device 114, and the controller device 116 to the I/O system 130. For example, in the implementation where the I/O system 130 includes the I/O module 132 and the I/O module 134 in a duplex configuration, the I/O module 132 and the I/O module 134 can provide four communication channels between the I/O system 130 and the network devices 122 and 124. In this implementation, the I/O module 132 can receive one data packet each from the network devices 122 and 124, and the I/O module 134 can likewise receive one data packet each from the network devices 122 and 124. However, in the triple simplex configuration as noted above, the network devices 122 and 124 may send only one data packet each to the I/O module 132, the I/O module 134, and the I/O module 136. Moreover, in the triple simplex configuration, one of the network devices 122 or 124 could be eliminated. In any event, the illustration provided in FIG. 1 is not intended to be limiting. Rather, the illustration provided in FIG. 1 shows one possible example of communication between the illustrated components of the control system 100.

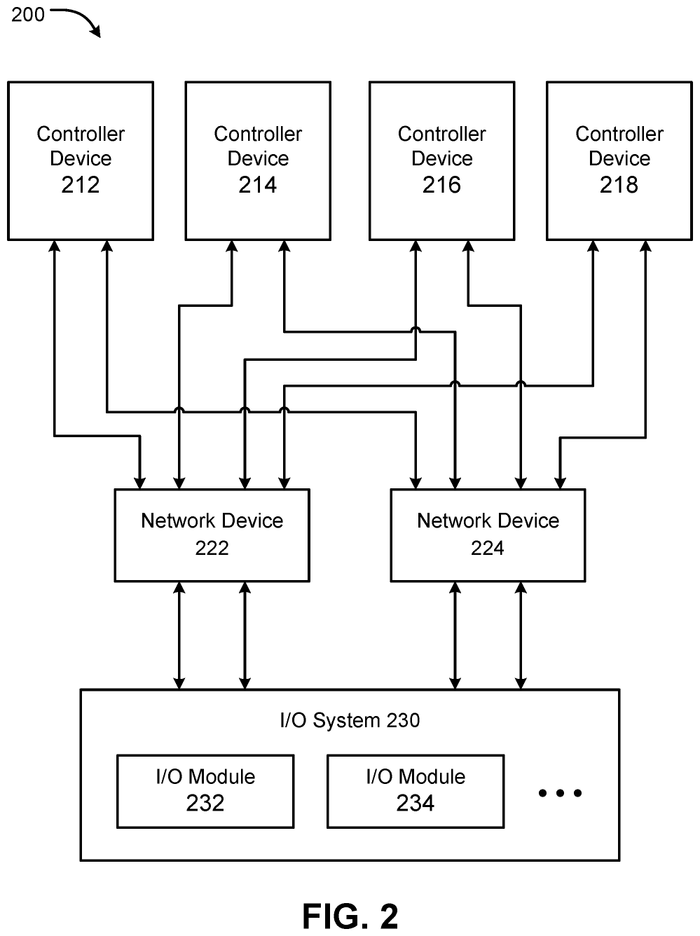

Referring to FIG. 2, a block diagram illustrating example components of another example control system 200 is shown, in accordance with some aspects of the disclosure. The control system 200 is similar to the control system 100 as discussed above. However, the control system 200 includes an added controller device 218 that can be used to provide added reliability and allow the control system 200 to recover from various types of failures. As shown, the control system 200 includes a controller device 212, a controller device 214, a controller device 216, and a controller device 218 as well as a network device 222 and a network device 224. Further, the control system 200 is shown to include an I/O system 230 that includes an I/O module 232 and an I/O module 234. The control system 200 can generally be used to control the operation of various types of equipment in various types of industrial facilities. For example, the control system 200 can be implemented in manufacturing facilities in industries such as aerospace, automotive, cement, chemical processing, food and beverage, household and personal care, life sciences, marine operations, metals processing, mining operations, oil and gas, power generation, print and publishing, pulp and paper, semiconductors, warehouse and fulfillment, and wastewater treatment, among others. In some implementations, the improved reliability that can be provided by the control system 200 can be particularly advantageous in industries such as oil and gas, chemical processing, and other safety critical automation environments.

The example components of the control system 200 including the controller device 212, the controller device 214, the controller device 216, the controller device 218, the network device 222, the network device 224, and the I/O system 230 including the I/O module 232 and the I/O module 234 can be in electrical communication with each other either directly or indirectly using various types and combinations of communications networks, protocols, and equipment. For example, the components of the control system 200 can communicate with each other using various types of wired and/or wireless communications including Ethernet/IP communications, serial communications, CIP safety communications, and other suitable communications protocols. For example, the components of the control system 200 can communicate with each other via one or more LANs in a manufacturing facility.

The controller device 212 can be implemented as a PLC device, among other possible types of controller devices that can be used in an industrial control system. The controller device 212 can include any suitable hardware, software, firmware, and communications interfaces (e.g., Ethernet communications port(s), serial communications port(s), power interface(s), etc.) for performing control functions within the control system 200. The controller device 212 can execute one or more control loops to process inputs and outputs and send control signals to affect operation of equipment in the control system 200. The controller device 212 can include various suitable configurations of hardware processing circuitry and memory. For example, the controller device 212 can include one or more CPUs and/or other types of hardware processing circuitry. The processing circuitry can be implemented using any number of processing cores, including single core processors, dual core processors, and other processor core configurations. The memory can include any suitable types of memory including different types of volatile memory, non-volatile memory, RAM, ROM, EEPROM, and/or other types of memory. The memory of the controller device 212 can include non-transitory computer readable storage media having instructions stored thereon for execution by the processing circuitry of the controller device 212 to cause the controller device 212 to perform various operations. For example, the instructions can cause the controller device 212 to implement the functionality pertaining to triple modular redundancy as described herein.

The controller device 214 and the controller device 216 can likewise be implemented in various ways, and can each include the same or similar components as discussed above with respect to the controller device 212. In some implementations, advantages can be provided when the controller device 212, the controller device 214, and the controller device 216 each have only a single core CPU to perform processing functionality. In such an implementation, the controller device 212, the controller device 214, and the controller device 216 can be provided at a lower cost relative to comparable devices that include multiple processors and/or multiple processor cores. Further, the controller device 212, the controller device 214, and the controller device 216 can be networked together to provide triple modular redundancy using separate controllers. Since multiple separate devices are used in such an implementation, improvements in terms of reliability can be provided relative to alternative implementations that use a single controller device with multiple processors and/or processor cores that provide triple modular redundancy via that single device. The circuitry of the controller device 212, the controller device 214, and the controller device 216 can be configured to generate and transmit various types of redundant output data packets (e.g., indicative of measured process variables, states, etc.) to the I/O system 230. The circuitry of the controller device 212, the controller device 214, and the controller device 216 can also be configured to receive control inputs (e.g., input data packets) from the I/O system 230 and use the control inputs to affect operation of equipment in the control system 230.

The controller device 218 can likewise be implemented in various ways, and can include the same or similar components as discussed above with respect to the controller device 212, the controller device 214, and the controller device 216. However, the controller device 218 generally serves as an extra stand-by controller device connected in the control system 200 that can be used in the event of various types of failures. For example, as will be detailed further below, various approaches including control loop comparisons and/or value comparisons can be used within the control system 200 to invalidate any of the controller device 212, the controller device 214, or the controller device 216, or any of the components of the I/O system 230 such as the I/O module 232 or the I/O module 234, during operation of the control system 200. In response to detecting a failure event, the control system 200 can temporarily transition to using a different voting process to validate data communications while the control system 200 brings the controller device 218 (or an extra I/O module of the I/O system 230) online to recover from the failure event. For example, in response to invalidating the controller device 216, the control system 200 (e.g., the controller device 212, the controller device 214, and/or the I/O system 230) can temporarily transition to a one out of two (1oo2) or a one out of two with diagnostics (1oo2D) voting process while recovering to the normal two out of three (2oo3) or two out of three with diagnostics (2oo3D) voting process.

The network device 222 can be implemented in a variety of ways, such as using various types of network switch devices and other suitable types of networking devices. The network device 222 can generally provide a communications interface between the controller device 212, the controller device 214, the controller device 216, the controller device 218, and the I/O system 230. For example, the network device 222 can receive output data packets from the controller device 212, the controller device 214, the controller device 216, and/or the controller device 218 and appropriately route the output data packets to the I/O system 230. The network device 222 can also receive control inputs from the I/O system 230 and appropriately route the control inputs to the controller device 212, the controller device 214, the controller device 216, and/or the controller device 218.

The network device 222 can also include various suitable configurations of hardware processing circuitry and memory. For example, the network device 222 can include one or more CPUs and/or other types of hardware processing circuitry. The processing circuitry can be implemented using any number of processing cores, including single core processors, dual core processors, and other processor core configurations. The memory can include any suitable types of memory including different types of volatile memory, non-volatile memory, RAM, ROM, EEPROM, and/or other types of memory. The memory of the network device 222 can include non-transitory computer readable storage media having instructions stored thereon for execution by the processing circuitry of the network device 222 to cause the network device 222 to perform various operations. For example, the instructions can cause the network device 222 to implement the functionality pertaining to routing communications related to triple modular redundancy as described herein. The network device 224 can likewise be implemented in various ways, and can include the same or similar components as discussed above with respect to the network device 222. The network device 222 and the network device 224 can, in some examples, facilitate black channel communication between the controller device 212, the controller device 214, the controller device 216, and/or the controller device 218 and the I/O system 230 based on PRP.

The I/O system 230 can also be implemented in a variety of ways using different types of components and configurations. For example, the I/O system 230 can be implemented as a FLEXHA 5000 I/O System as provided by Rockwell Automation, Inc., among other similar types of I/O systems. The I/O system 230 can include, for example, one or more backplanes such as redundant backplanes that provide communications between different components of the I/O system 230. The I/O system 130 can generally be a “high availability” (HA) system that can provide above a threshold level of uptime (e.g., a threshold uptime percentage, etc.). The I/O system 230 can include various mechanical and electromechanical components such as mounting plates, terminal blocks, power conditioners, network adapters, landing cards, interface modules, adapter bases, ground lugs, expansion bases, shielding components, cables and other wiring, power supply modules, and/or other suitable components. The I/O system 230 can be installed in various locations in a given facility such as within a given electrical cabinet or distributed across multiple electrical cabinets.

While the I/O system 230 is shown to include two I/O modules including the I/O module 232 and the I/O module 234 the I/O system 230 can be implemented using a variety of I/O module configurations. For example, the I/O system 230 can include four I/O modules that provide a quadruple simplex configuration between the controller device 212, the controller device 214, the controller device 216, the controller device 218, and the I/O system 230. As another example, the I/O system 230 can be implemented using just the I/O module 232 and the I/O module 234 as shown, where each of the I/O module 232 and the I/O module 234 are duplex (redundant) modules. In such a configuration, the I/O system 230 can include a third I/O module connected to the controller device 218 that can be used in the event of a failure. The I/O module 232 and the I/O module 234 can each be rated for SIL 2. The controller device 212, the controller device 214, and the controller device 216 can likewise each be rated for SIL2. However, by networking these components together and implementing the functionality described herein, a higher rating of SIL3 can be provided for the control system 200 more broadly. The processing steps described herein as being performed by circuitry of the I/O system 230 can be performed by different components and/or combinations of components of the I/O system 230 depending on the application.

As suggested by the block diagram shown in FIG. 2, the controller device 212, the controller device 214, the controller device 216, and/or (if needed) the controller device 218 can each send redundant copies of the same output data packet to both the network device 222 and the network device 224. Then, the network device 222 and the network device 224 can each send redundant packets containing the output data from the controller device 212, the controller device 214, the controller device 216, and/or (if needed) the controller device 218 to the I/O system 230. For example, in the implementation where the I/O system 230 includes the I/O module 232 and the I/O module 234 in a duplex configuration, the I/O module 232 and the I/O module 234 can provide four communication channels between the I/O system 230 and the network devices 222 and 224. In this implementation, the I/O module 232 can receive one data packet each from the network devices 222 and 224, and the I/O module 234 can likewise receive one data packet each from the network devices 222 and 224. However, in the quadruple simplex configuration as noted above, the network devices 222 and 224 may send only one data packet each to four I/O modules in the I/O system 230. Moreover, in the quadruple simplex configuration, one of the network devices 222 or 224 could be eliminated. In any event, the illustration provided in FIG. 2 is not intended to be limiting. Rather, the illustration provided in FIG. 2 shows one possible example of communication between the illustrated components of the control system 200.

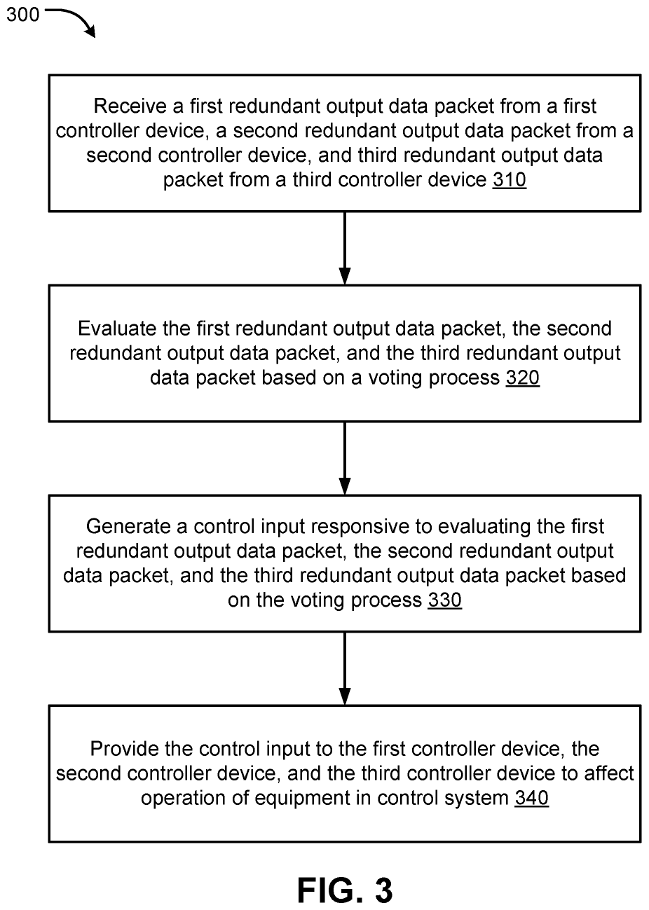

Referring to FIG. 3, a flowchart illustrating steps of an example process 300 for providing triple modular redundancy using separate controllers that can be implemented in the control system 100 and/or in the control system 200 is shown, in accordance with some aspects of the disclosure. The process 300 can generally be used to provide triple modular redundancy by leveraging multiple separate, existing controller nodes. For example, existing controllers rated for SIL2 can be networked together using the process 300 to provide a system rated for SIL3 that uses a 2oo3 voting process. Further, the process 300 can use control loop comparisons between the controllers to provide a simulated lockstep system. Moreover, the process 300 can use cross checking value comparisons to provide added reliability. The process 300 can also leverage standby components such as extra controllers and/or extra I/O components to provide recovery functionality in the event of various types of failures. As such, the process 300 can allow for the provision of an SIL3 rated system in some industrial applications without requiring significant costs to upgrade to all SIL3 rated equipment.

At 310, the process 300 is shown to include receiving a first redundant output data packet from a first controller device, a second redundant output data packet from a second controller device, and a third redundant output data packet from a third controller device. For example, the I/O system 230 can receive the first output data packet from the controller device 212, the second output data packet from the controller device 214, and the third output data packet from the controller device 216. The first output data packet, the second output data packet, and the third output data packet can each be CIP safety-encoded data packets and can include various different information pertaining to the control system 200. For example, the first output data packet, the second output data packet, and the third output data packet can include measured process variables and status information associated with equipment in the control system 200 (e.g., temperature values, pressure values, on/off statuses, etc.).

The I/O system 230 can receive the first output data packet from the controller device 212, the second output data packet from the controller device 214, and the third output data packet from the controller device 216 in various ways, such as, for example, directly or through the network device 222 and/or the network device 224. Also, in some examples, the I/O system 230 can receive two instances each of the first output data packet from the controller device 212, the second output data packet from the controller device 214, and the third output data packet from the controller device 216. The first instance of each of the first output data packet, the second output data packet, and the third output data packet can be received at a first redundant I/O module (e.g., the I/O module 232) and the second instance of each of the first output data packet, the second output data packet, and the third output data packet can be received at a second redundant I/O module (e.g., the I/O module 234).

Additionally, in implementations where both the network device 222 and the network device 224 are included in the control system 200, for example, the I/O system 230 can receive four instances each of the first output data packet from the controller device 212, the second output data packet from the controller device 214, and the third output data packet from the controller device 216. For example, the first redundant I/O module (e.g., the I/O module 232) can receive both a first instance of each of the first output data packet, the second output data packet, and the third output data packet from the network device 222 and a second instance of each of the first output data packet, the second output data packet, and the third output data packet from the network device 224. Then, the second redundant I/O module (e.g., the I/O module 234) can receive both a third instance of each of the first output data packet, the second output data packet, and the third output data packet from the network device 222 and a fourth instance of each of the first output data packet, the second output data packet, and the third output data packet from the network device 224 to provide added reliability. Further, three separate I/O modules (e.g., the I/O modules 132, 134, 136 in the I/O system 130) could each receive three separate instances of the three data packets from the three control devices.

At 320, the process 300 is shown to include evaluating the first redundant output data packet, the second redundant output data packet, and the third redundant output data packet based on a voting process. The voting process during normal operation can be a 2oo3D voting process (or a 2oo3 voting process) performed by the I/O system 230. However, during recovery after a failure event, the control system 200 can temporarily transition to a 1oo2D voting process (or a 1oo2 voting process). Moreover, in certain scenarios, a fourth controller device (e.g., the controller device 218) could be used during normal operation of the control system 200, and a 3oo4 voting process could be implemented. The control system 200 can perform various types of evaluations at 320 to validate the first redundant output data packet, the second redundant output data packet, and the third redundant output data packet and/or the associated components. For example, the control system 200 can perform control loop comparisons and/or value comparison.

In a control loop comparison, the controller device 212, the controller device 214, and the controller device 216, the controller device 218, and/or the I/O system 230 can analyze changes in one or more control loops to identify inconsistencies indicative of a failure. For example, the controller device 212, the controller device 214, and the controller device 216, the controller device 218, and/or the I/O system 230 can count the number of times a control loop executes and/or analyze states of different variables associated with a control loop at comparable time intervals to identify any potential inconsistencies. Responsive to detecting an inconsistency, the I/O system 230, for example, can invalidate the controller device 212, the controller device 214, the controller device 216, and/or the controller device 218 appropriately. For example, responsive to detecting an inconsistency associated with the controller device 216, the I/O system 230 can invalidate the controller device 216 and evaluate only the first redundant output data packet and the second redundant output data packet using a 1oo2D voting process. Then, the I/O system 230 can also activate the controller device 218 (e.g., by sending a signal through the network device 222 and/or the network device 224) responsive to invalidating the controller device 216. After activating the controller device 218, the I/O system 230 can receive a fourth redundant output data packet from the controller device 212, a fifth redundant output data packet from the controller device 214, and a sixth redundant output data packet from the controller device 218. The I/O system 230 can then recover back to 2oo3D operation and evaluate the fourth redundant output data packet, the fifth redundant output data packet, and the sixth redundant output data packet based on a 2oo3D voting process and generate and provide a control input responsive to that evaluation.

In a value comparison, the controller device 212, the controller device 214, and the controller device 216, the controller device 218, and/or the I/O system 230 can analyze values associated with output and input data to identify inconsistencies indicative of a failure. For example, the I/O system 230 can evaluate various instances of the first redundant output data packet, the second redundant output data packet, and the third redundant output data packet relative to each other to identify any potential inconsistencies. Additionally, the controller device 212, the controller device 214, and the controller device 216, the controller device 218, and/or the I/O system 230 can evaluate any control input instances relative to each other to identify any potential inconsistencies. Responsive to detecting an inconsistency, the I/O system 230, for example, can invalidate the controller device 212, the controller device 214, the controller device 216, the controller device 218, the I/O module 232, and/or the I/O module 234 appropriately (or the I/O system 130 can similarly invalidate any of the I/O modules 132, 134, 136) based on the value comparison. The I/O system can then activate the controller device 218 and/or activate a standby I/O module in the I/O system 230 while temporarily transitioning to a 1oo2D voting process.

At 330, the process 300 is shown to include generating a control input responsive to evaluating the first redundant output data packet, the second redundant output data packet, and the third redundant output data packet based on the voting process. The control input can be any suitable control input that can be used by the controller device 212, the controller device 214, and the controller device 216 to affect operation of equipment in the control system 200, for example. The controller device 212, the controller device 214, and/or the controller device 216 can each use the control input as in a control loop to determine an appropriate control signal to send to equipment in the control system 200, for example. At 340, the process 300 is shown to include providing the control input to the first controller device, the second controller device, and the third controller device to affect operation of equipment in the control system. For example, the I/O system 230 can provide one or more instances of the control input to the controller device 212, the controller device 214, and the controller device 216 either directly or indirectly, such as through the network device 222 and/or the network device 224.

While the steps of the process 300 are shown in a particular order in FIG. 3, the process 300 may not include all steps shown, may include additional steps, or may include the steps in a different order.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A control system, comprising:
a first controller device comprising circuitry configured to generate and transmit a first redundant output data packet associated with the control system;
a second controller device comprising circuitry configured to generate and transmit a second redundant output data packet associated with the control system;
a third controller device comprising circuitry configured to generate and transmit a third redundant output data packet associated with the control system;
an input/output (I/O) system comprising circuitry configured to:
receive the first redundant output data packet, the second redundant output data packet, and the third redundant output data packet from the first controller device, the second controller device, and the third controller device;
evaluate the first redundant output data packet, the second redundant output data packet, and the third redundant output data packet based on a voting process;
generate a control input responsive to evaluating the first redundant output data packet, the second redundant output data packet, and the third redundant output data packet based on the voting process; and
provide the control input to the first controller device, the second controller device, and the third controller device such that the first controller device, the second controller device, and the third controller device use the control input to affect operation of equipment in the control system.

2. The control system of claim 1, wherein the voting process comprises a two out of three (2oo3) or a two out of three with diagnostics (2oo3D) voting process.

3. The control system of claim 1, wherein the circuitry of the I/O system is configured to:
evaluate the first redundant output data packet, the second redundant output data packet, and the third redundant output data packet based on a control loop comparison; and
invalidate the third controller device based on the control loop comparison;
wherein the voting process comprises a one out of two (1oo2) or a one out of two with diagnostics (1oo2D) voting process that is based on the first redundant output data packet and the second redundant output data packet.

4. The control system of claim 3, wherein the circuitry of the I/O system is configured to:
activate a fourth controller device responsive to invalidating the third controller device based on the control loop comparison;
receive a fourth redundant output data packet from the first controller device, a fifth redundant output data packet from the second controller device, and a sixth redundant output data packet from the fourth controller device after activating the fourth controller device;
evaluate the fourth redundant output data packet, the fifth redundant output data packet, and the sixth redundant output data packet based on a two out of three (2oo3) or a two out of three with diagnostics (2oo3D) voting process;
generate a second control input responsive to evaluating fourth redundant output data packet, the fifth redundant output data packet, and the sixth redundant output data packet based on the 2oo3 or the 2oo3D voting process; and
provide the second control input to the first controller device, the second controller device, and the fourth controller device such that the first controller device, the second controller device, and the fourth controller device use the second control input to affect operation of the equipment in the control system.

5. The control system of claim 1, wherein the I/O system comprises:
a first redundant I/O module comprising circuitry configured to receive, from a first networking device in communication with the first controller device, the second controller device, and the third controller device, a first instance of the first redundant output data packet, a first instance of the second redundant output data packet, and a first instance of the third redundant output data packet; and
a second redundant I/O module comprising circuitry configured to receive, from a second networking device in communication with the first controller device, the second controller device, and the third controller device, a second instance of the first redundant output data packet, a second instance of the second redundant output data packet, and a second instance of the third redundant output data packet.

6. The control system of claim 5, wherein the circuitry of the I/O system is configured to:
perform a value comparison by evaluating the first instance of the first redundant output data packet relative to the second instance of the first redundant output data packet, evaluating the first instance of the second redundant output data packet relative to the second instance of the second redundant output data packet, and evaluating first instance of the third redundant output data packet relative to the second instance of the third redundant output data packet; and
invalidate the second redundant I/O module based on the value comparison.

7. The control system of claim 1, wherein:
the first controller device comprises a first programmable logic controller (PLC) and the first redundant output data packet comprises a first Common Industrial Protocol (CIP) safety-encoded data packet;
the second controller device comprises a second PLC and the second redundant output data packet comprises a second CIP safety-encoded data packet; and
the third controller device comprises a third PLC and the third redundant output data packet comprises a third CIP safety-encoded data packet.

8. The control system of claim 1, wherein the I/O system comprises:
a first redundant I/O module comprising circuitry configured to receive a first instance of the first redundant output data packet, a first instance of the second redundant output data packet, and a first instance of the third redundant output data packet;
a second redundant I/O module comprising circuitry configured to receive a second instance of the first redundant output data packet, a second instance of the second redundant output data packet, and a second instance of the third redundant output data packet; and
a third redundant I/O module comprising circuitry configured to receive a third instance of the first redundant output data packet, a third instance of the second redundant output data packet, and a third instance of the third redundant output data packet.

9. The control system of claim 8, wherein the circuitry of the I/O system is configured to:
perform a value comparison by evaluating the first instance, the second instance, and the third instance of the first redundant output data packet relative to each other, evaluating the first instance, the second instance, and the third instance of the second redundant output data packet relative to each other, and evaluating first instance, the second instance, and the third instance of the third redundant output data packet relative to each other; and
invalidate the third redundant I/O module based on the value comparison.

10. A method for use in a control system, the method comprising:
receiving, from a first controller device, a first redundant output data packet associated with the control system;
receiving, from a second controller device, a second redundant output data packet associated with the control system;
receiving, from a third controller device, a third redundant output data packet associated with the control system;
evaluating the first redundant output data packet, the second redundant output data packet, and the third redundant output data packet based on a voting process;
generating a control input responsive to evaluating the first redundant output data packet, the second redundant output data packet, and the third redundant output data packet based on the voting process; and
providing the control input to the first controller device, the second controller device, and the third controller device such that the first controller device, the second controller device, and the third controller device use the control input to affect operation of equipment in the control system.

11. The method of claim 10, comprising:
evaluating the first redundant output data packet, the second redundant output data packet, and the third redundant output data packet based on a control loop comparison; and
invalidating the third controller device based on the control loop comparison;
wherein the voting process comprises a one out of two (1oo2) or a one out of two with diagnostics (1oo2D) voting process that is based on the first redundant output data packet and the second redundant output data packet.

12. The method of claim 11, comprising:
activating a fourth controller device responsive to invalidating the third controller device based on the control loop comparison;
receiving a fourth redundant output data packet from the first controller device, a fifth redundant output data packet from the second controller device, and a sixth redundant output data packet from the fourth controller device after activating the fourth controller device;
evaluating the fourth redundant output data packet, the fifth redundant output data packet, and the sixth redundant output data packet based on a two out of three (2oo3) or a two out of three with diagnostics (2oo3D) voting process;
generating a second control input responsive to evaluating fourth redundant output data packet, the fifth redundant output data packet, and the sixth redundant output data packet based on the 2oo3 or the 2oo3D voting process; and
providing the second control input to the first controller device, the second controller device, and the fourth controller device such that the first controller device, the second controller device, and the fourth controller device use the second control input to affect operation of the equipment in the control system.

13. The method of claim 10, wherein the voting process comprises a two out of three (2oo3) or a two out of three with diagnostics (2oo3D) voting process.

14. The method of claim 10, wherein:
the first controller device comprises a first programmable logic controller (PLC) and the first redundant output data packet comprises a first Common Industrial Protocol (CIP) safety-encoded data packet;
the second controller device comprises a second PLC and the second redundant output data packet comprises a second CIP safety-encoded data packet; and
the third controller device comprises a third PLC and the third redundant output data packet comprises a third CIP safety-encoded data packet.

15. One or more non-transitory computer-readable storage media having instructions stored thereon that, when executed by processing circuitry, cause the processing circuitry to:
receive, from a first controller device, a first redundant output data packet associated with a control system;
receive, from a second controller device, a second redundant output data packet associated with the control system;
receive, from a third controller device, a third redundant output data packet associated with the control system;
evaluate the first redundant output data packet, the second redundant output data packet, and the third redundant output data packet based on a voting process;
generate a control input responsive to evaluating the first redundant output data packet, the second redundant output data packet, and the third redundant output data packet based on the voting process; and
provide the control input to the first controller device, the second controller device, and the third controller device such that the first controller device, the second controller device, and the third controller device use the control input to affect operation of equipment in the control system.

16. The computer-readable media of claim 15, wherein the instructions cause the processing circuitry to:
evaluate the first redundant output data packet, the second redundant output data packet, and the third redundant output data packet based on a control loop comparison; and
invalidate the third controller device based on the control loop comparison;
wherein the voting process comprises a one out of two (1oo2) or a one out of two with diagnostics (1oo2D) voting process that is based on the first redundant output data packet and the second redundant output data packet.

17. The computer-readable media of claim 16, wherein the instructions cause the processing circuitry to:
activate a fourth controller device responsive to invalidating the third controller device based on the control loop comparison;
receive a fourth redundant output data packet from the first controller device, a fifth redundant output data packet from the second controller device, and a sixth redundant output data packet from the fourth controller device after activating the fourth controller device;
evaluate the fourth redundant output data packet, the fifth redundant output data packet, and the sixth redundant output data packet based on a two out of three (2oo3) or a two out of three with diagnostics (2oo3D) voting process;
generate a second control input responsive to evaluating fourth redundant output data packet, the fifth redundant output data packet, and the sixth redundant output data packet based on the 2oo3 or the 2oo3D voting process; and
provide the second control input to the first controller device, the second controller device, and the fourth controller device such that the first controller device, the second controller device, and the fourth controller device use the second control input to affect operation of the equipment in the control system.

18. The computer-readable media of claim 15, wherein the voting process comprises a two out of three with diagnostics (2oo3D) voting process.

19. The computer-readable media of claim 15, wherein the voting process comprises a two out of three (2oo3) voting process.

20. The computer-readable media of claim 15, wherein:
the first controller device comprises a first programmable logic controller (PLC) and the first redundant output data packet comprises a first Common Industrial Protocol (CIP) safety-encoded data packet;
the second controller device comprises a second PLC and the second redundant output data packet comprises a second CIP safety-encoded data packet; and
the third controller device comprises a third PLC and the third redundant output data packet comprises a third CIP safety-encoded data packet.
